(19) United States
(12) Patent Application Publication
(10) Pub. No.: US 2009/0139550 A1
(43) Pub. Date: Jun. 4, 2009

(54) STEAM GENERATOR

(75) Inventor: Min Kyu LIM, Changwon-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/184,080

(22) Filed: Jul. 31, 2008

(30) Foreign Application Priority Data
Aug. 3, 2007 (KR) 10-2007-0078070

(51) Int. Cl. B08B 3/10; F22B 1/28; D06B 19/00; D06F 35/00

(52) U.S. Cl. 134/107; 392/394; 392/401; 68/5 C

(57) ABSTRACT

A steam generator is disclosed. The steam generator includes a housing for containing water and a heater installed such that at least one portion of the heater is buried in a bottom of the housing to indirectly heat the water in the housing.

### CROSS-REFERENCE TO RELATED APPLICATION

This application claims the benefit of Korean Patent Application No. 10-2007-0078070, filed on Aug. 3, 2007, which is hereby incorporated by reference in its entirety as if fully set forth herein.

### BACKGROUND OF THE INVENTION

1. Field of the Invention

The present invention relates to a steam generator, and more particularly to a steam generator capable of more efficiently heating water to generate steam.

2. Discussion of the Related Art

Recently, clothes treating machines, for example, a washing machine, a dryer and a refresher, mostly include a steam generator for supplying steam to clothes.

In the washing machine, the steam supplied in an initial period allows the clothes to quickly get wet, the steam supplied in a rinsing operation provides a sterilizing effect, and the steam supplied in a drying operation removes wrinkles from the clothes.

Further, the steam sprayed in the dryer or the refresher provides a sterilizing effect, removes wrinkles from the clothes, and swells the clothes to provide a refresh effect.

In order to spray the steam in the clothes treating machine, generally, a steam generator for generating steam is provided at one side of the clothes treating machine. The steam generator generally includes a housing for containing water and a heater for heating the water in the housing. When the water is supplied into the housing, the heater is in direct contact with the water to heat the water and generate steam.

However, when the heater heats the water in direct contact with the water, a contact area between the heater and the water is restricted to the surface of the heater. Since the heat generated from the heater is transferred only by water in contact with the heater, heating efficiency sharply decreases.

Further, in the above-mentioned steam generator, since the water in contact with the heater is heated first, it is difficult to uniformly heat the water. Accordingly, nonuniform temperature distribution is formed in the housing and durability of the housing is reduced. Thus, it causes malfunction of the steam generator or shortens a life span of the steam generator.

### SUMMARY OF THE INVENTION

Accordingly, the present invention is directed to a steam generator that substantially obviates one or more problems due to limitations and disadvantages of the related art.

An object of the present invention is to provide a steam generator capable of more efficiently heating water to generate steam.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a steam generator comprises: a housing for containing water; and a heater installed such that at least one portion of the heater is buried in a bottom of the housing to indirectly heat the water in the housing.

Preferably, the heater is buried without being exposed to an inner space of the housing.

Preferably, the heater is entirely buried in the bottom of the housing.

Preferably, the heater is buried to be exposed downward from the bottom of the housing.

Preferably, the bottom of the housing is formed of a material having high thermal conductivity.

Preferably, the bottom of the housing is formed of iron or aluminum.

Preferably, the steam generator further comprises a discharge line which discharges steam generated in the housing and is installed adjacent to the heater.

Preferably, the discharge line is buried in the bottom of the housing.

Preferably, the discharge line is installed under the heater.

Preferably, the steam generator further comprises a temperature sensor for measuring a temperature of the bottom of the housing.

Preferably, the steam generator further comprises a controller which controls an operation of the heater to be stopped when the temperature measured by the temperature sensor is a predetermined temperature or more.

In accordance with another purpose of the invention, a clothes treating machine comprises: a receiving space for receiving clothes; and a steam generator for selectively supplying steam into the receiving space, the steam generator having a housing for containing water and a heater installed such that at least one portion of the heater is buried in a bottom of the housing to heat the water in the housing.

In accordance with a further purpose of the invention, a dish washing machine comprises: a receiving space for receiving dishes; a spray unit for supplying wash water into the receiving space; and a steam generator for selectively supplying steam into the receiving space, the steam generator having a housing for containing water and a heater installed such that at least one portion of the heater is buried in a bottom of the housing to heat the water in the housing.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a cross-sectional view showing a steam generator;

FIG. 2 is a cross-sectional view showing a steam generator according to a first embodiment of the present invention;

FIG. 3 is a right side view of FIG. 2;

FIG. 4 is a cross-sectional view showing a steam generator according to a second embodiment of the present invention; and

FIG. 5 is a right side view of FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, embodiments of the present invention will be described in detail with reference to the accompanying drawings.

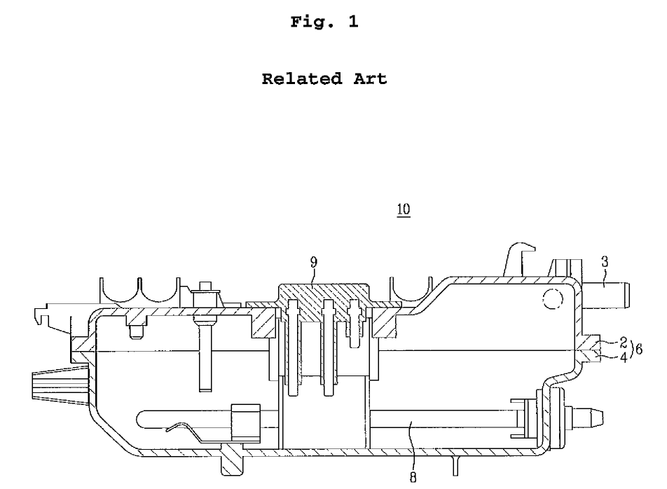

FIG. 1 illustrates a cross-sectional view showing an inner structure of a steam generator.

Referring to FIG. 1, a steam generator 10 includes a housing 6 for containing water and a heater 8 for heating the water in the housing 6. The housing 6 may include an upper housing 2 and a lower housing 4. Further, the steam generator 10 may include a water level sensor 9 for sensing a level of the water contained in the housing 6.

The water supplied into the housing 6 through a water supply port 3 is heated by the heater 8. The heater 8 is positioned adjacent to the bottom in the housing 6. Accordingly, when the water is supplied into the housing 6, the heater 8 is in direct contact with the water to heat the water and generate steam.

However, in the steam generator 10, since the heater 8 heats water in direct contact with water, a contact area between the heater 8 and water is restricted to the surface of the heater 8. Accordingly, since the heat generated from the heater 8 is transferred only by water in contact with the heater, heating efficiency sharply decreases.

Further, in the steam generator 10, since the water in contact with the heater 8 is heated first, it is difficult to uniformly heat the water. Accordingly, nonuniform temperature distribution is formed in the housing 6 and durability of the housing 6 is reduced. Thus, it causes malfunction of the steam generator 10 or shortens a life span of the steam generator 10.

A steam generator capable of solving the above problems is required to be devised and the steam generator will be described in detail with reference to the accompanying drawings.

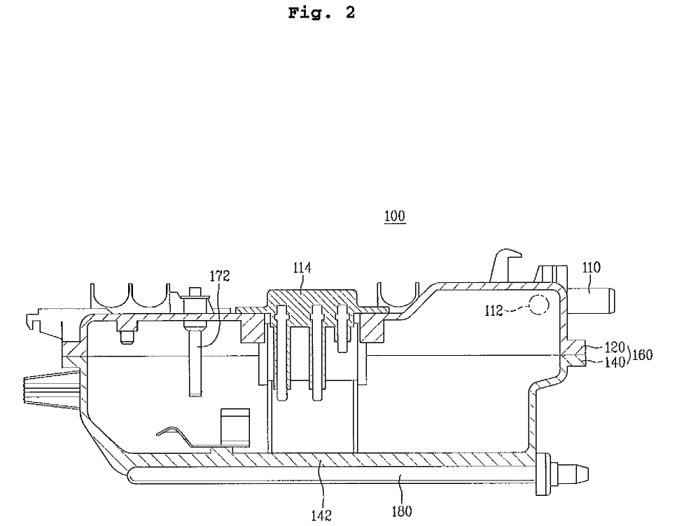

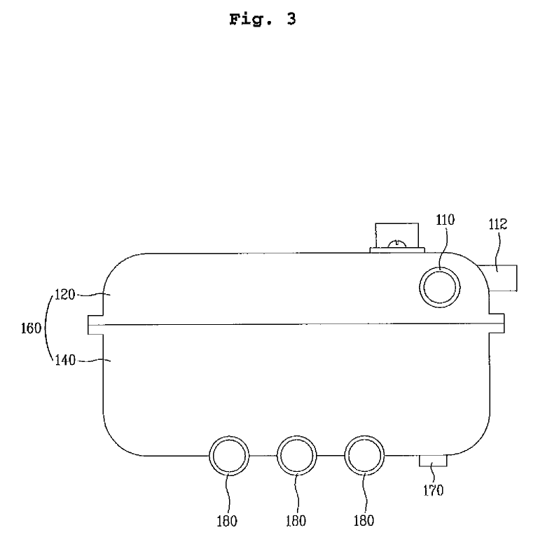

FIG. 2 is a longitudinal cross-sectional view showing a steam generator according to a first embodiment of the present invention. FIG. 3 is a right side view of FIG. 2.

Referring to FIGS. 2 and 3, a steam generator 100 according to the first embodiment include a housing 160 in which water is contained and heated, and a heater 180 for heating the water in the housing 160 to generate steam.

The housing 160 forms an external appearance of the steam generator 100 and includes an upper housing 120 and a lower housing 140. The housing 160 has an appropriate receiving space therein and receives water supplied through a water supply port 110. In this case, an external water tap or a detachable water cartridge may be used as a water supply source.

Meanwhile, a water level sensor 114 for sensing a water level in the housing 160 may be provided at one side of the housing 160. When the water is supplied into the housing 160, the water level sensor 114 measures a water level. Accordingly, when an appropriate amount of water is supplied into the housing 160, a controller (not shown) stops water supply according to the water level measured by the water level sensor 114.

When the water is supplied into the housing 160, the water is heated by the heater 180. In this embodiment, in order to increase an area of water heated by the heater 180 and uniformly heat the water, the heater 180 is provided to indirectly heat the water in the housing 160 instead of directly heating the water. That is, in this embodiment, at least one portion of the heater 180 is buried in a bottom 142 of the housing 160.

When the heater 180 heats the water in a state where at least one portion of the heater 180 is buried in the bottom 142 of the housing 160, the heat generated from the heater 180 is indirectly transferred to the water through the bottom 142. That is, the heater 180 heats the bottom 142 and the heated bottom 142 heats the water. Accordingly, in this embodiment, since the heater 180 heats water through the bottom 142 of the housing 160, differently from a conventional heater which heats water in direct contact with the water, it is possible to enlarge a heated area of water and also to enhance efficiency of heating water.

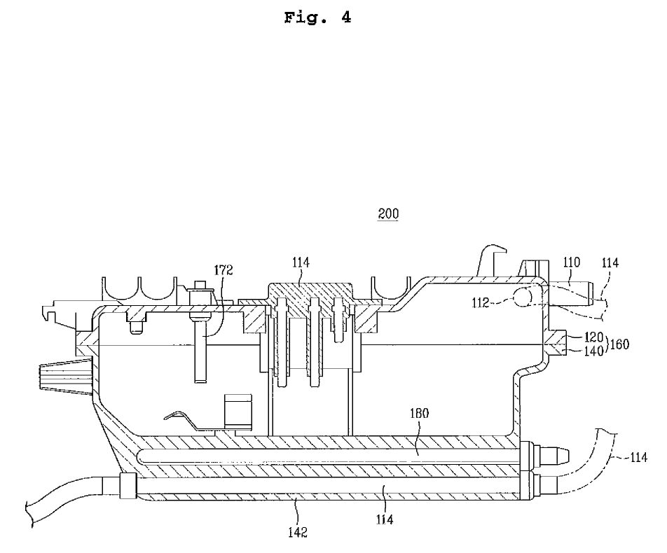

In this case, preferably, the heater 180 is buried in the bottom 142 of the housing 160 such that the heater 180 is not protruded to the receiving space inside the housing 160. Accordingly, when the heater 180 is buried in the bottom 142 of the housing 160, the entire heater 180 may be buried in the bottom 142 of the housing 160 as shown in FIG. 4, or a portion of the heater 180 may be exposed through a lower portion of the bottom 142 as shown in FIGS. 2 and 3. Preferably, the heater 180 is buried in the bottom 142 without being exposed to the receiving space of the housing 160. As for the reason, when a portion of the heater 180 is exposed to the receiving space of the housing 160 through an upper portion of the bottom 142, the heater 180 is in direct contact with the water to reduce efficiency of the heater 180 in heating the bottom 142.

Further, when the bottom 142 is heated by the heater 180, preferably, the bottom 142 is formed of a material having high thermal conductivity. As for the reason, a material having high thermal conductivity can quickly transfer heat to quickly heat the water. The bottom 142 may be formed of iron or aluminum, but is not limited thereto.

Meanwhile, the steam generator according to this embodiment may further include a temperature sensor 170 for measuring the temperature of the housing 160. Preferably, the temperature sensor 170 is installed separately from a water temperature sensor 172 for measuring the temperature of water in the housing 160.

Specifically, the temperature sensor 170 is positioned at the bottom 142 of the housing 160 to measure the temperature of the bottom 142. The temperature of the bottom 142 of the housing 160 is measured to prevent the housing 160 from being damaged as the temperature of the bottom 142 increases to a predetermined temperature or more.

That is, if there is no water or a small amount of water in the housing 160, when the water is heated through the bottom 142, the temperature of the bottom 142 rapidly increases due to an insufficient amount of water, thereby causing damage and breakage of the housing 160. Accordingly, in this embodiment, the temperature of the bottom 142 is measured by the temperature sensor 170 and the measured temperature is transmitted to the controller. The controller compares the measured temperature with a preset temperature and stops the operation of the heater 180 if the measured temperature increases to a predetermined temperature or more, thereby preventing damage of the housing 160.

Meanwhile, the steam generated by the steam generator having the above configuration is supplied to a desired position through a steam discharge port 112 and a steam discharge line 114 (see FIG. 4). However, generally, since a position at which the steam is sprayed is spaced from the steam generator by a specific distance, the temperature of the steam may decrease or the steam may be converted into condensed water while the steam moves through the steam discharge line 114. When the temperature of the steam decreases, the steam cannot provide a sterilizing or refresh effect. Further, when the condensed water is produced, the condensed water is sprayed with the steam. Accordingly, when the steam is supplied to the clothes, the clothes get wet due to the condensed water.

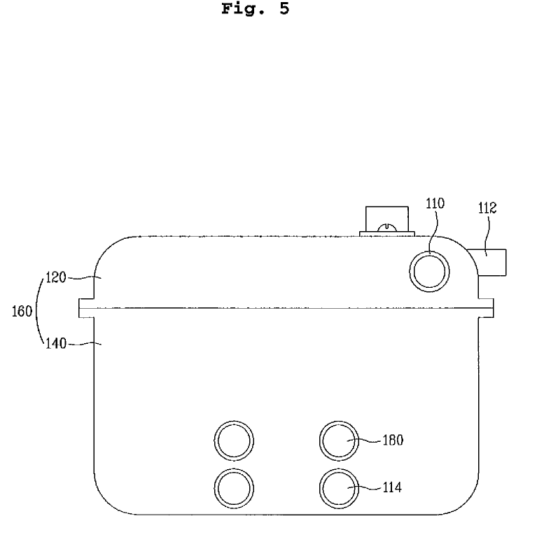

FIGS. 4 and 5 illustrate a configuration of the steam generator devised to solve the above-mentioned problem. That is, FIG. 4 is a cross-sectional view showing a steam generator according to a second embodiment of the present invention. FIG. 5 is a right side view of FIG. 4. For convenience of explanation, parts having the same configuration as those of the above embodiment are designated by the same reference numerals.

Referring to FIGS. 4 and 5, a steam generator 200 according to the second embodiment is different from the above-described steam generator in that the steam discharge line 114 for discharging steam is buried in the bottom 142 of the housing 160.

That is, also in this embodiment, the bottom 142 is heated by the heater 180 to heat the water. Accordingly, when the steam discharge line 114 in which the steam moves is buried in the bottom 142, heat generated in the bottom 142 heats not only the water in the housing 160, but also the steam in the steam discharge line 114. Accordingly, the temperature of the steam in the steam discharge line 114 can be maintained, thereby preventing the temperature of the steam from decreasing and also preventing the steam from being condensed.

Further, in the above configuration, the steam can be provided as superheated steam. Generally, the steam generated by heating water has a temperature of about 100° C. In sterilization using the steam having a temperature of about 100° C., general bacteria can be removed, but bacteria capable of surviving at a temperature of 100° C. or more cannot be removed. For example, it is known that a mold or fungus is removed at a temperature of 120° C. or more. In this embodiment, the steam discharge line 114 is installed in the bottom 142 to heat the steam moving through the steam discharge line 114, thereby providing superheated steam having a temperature of 120° C. or more. Thus, the sterilizing effect can be maximized by spraying the superheated steam to the clothes or dishes.

Meanwhile, when the steam discharge line 114 is buried in the bottom 142 of the housing 160, it is preferable to install the steam discharge line 114 under the heater 180. As for the reason, if the steam discharge line 114 is buried in the bottom 142 above the heater 180, the amount of heat, supplied from the heater 180 to the water through the bottom 142, decreases and it takes long time to generate steam.

Hereinafter, the operation of the steam generator having the above configuration will be described with reference to the accompanying drawings.

When the steam generator 100 or 200 according to the present invention is installed at, for example, a clothes treating machine for supplying steam to the clothes, first, water is supplied into the housing 160. As described above, an external water tap or a water cartridge may be used as a water supply source.

Then, the heater 180 is operated to generate steam. The heater 180 heats the bottom 142 of the housing 160, and the water is heated by the bottom 142 to generate steam. Accordingly, it is possible to enlarge a heated area of water and enhance efficiency of heating water.

The generated steam is supplied through the steam discharge line 114 buried in the bottom 142 of the housing 160. In this case, heat generated in the bottom 142 prevents the temperature of the steam from decreasing and also prevents the steam from being condensed.

Meanwhile, the temperature sensor 170 is installed at the bottom 142 of the housing 160. When there is a small amount of water or no water in the housing 160, if the temperature of the bottom 142 increases to a predetermined temperature or more, the temperature sensor 170 senses the temperature increase and transmits it to the controller such that the controller stops the operation of the heater 180.

Meanwhile, the steam generator according to the aforementioned embodiments may be applied to other machines using steam in addition to the clothes treating machine. For example, the steam generator according to the present invention may be applied to a dish washing machine to spray steam to the dishes before washing the dishes in order to easily wash foreign matter and the like.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A steam generator comprising:
a housing for containing water; and
a heater installed such that at least one portion of the heater is buried in a bottom of the housing to indirectly heat the water in the housing.

2. The steam generator according to claim 1, wherein the heater is buried without being exposed to an inner space of the housing.

3. The steam generator according to claim 2, wherein the heater is entirely buried in the bottom of the housing.

4. The steam generator according to claim 2, wherein the heater is buried to be exposed downward from the bottom of the housing.

5. The steam generator according to claim 2, wherein the bottom of the housing is formed of a material having high thermal conductivity.

6. The steam generator according to claim 5, wherein the bottom of the housing is formed of iron or aluminum.

7. The steam generator according to claim 2, further comprising a discharge line which discharges steam generated in the housing and is installed adjacent to the heater.

8. The steam generator according to claim 7, wherein the discharge line is buried in the bottom of the housing.

9. The steam generator according to claim 8, wherein the discharge line is installed under the heater.

10. The steam generator according to claim 2, further comprising a temperature sensor for measuring a temperature of the bottom of the housing.

11. The steam generator according to claim 10, further comprising a controller which controls an operation of the heater to be stopped when the temperature measured by the temperature sensor is a predetermined temperature or more.

12. A clothes treating machine comprising:
a receiving space for receiving clothes; and
a steam generator for selectively supplying steam into the receiving space, the steam generator having a housing for containing water and a heater installed such that at least one portion of the heater is buried in a bottom of the housing to heat the water in the housing.

13. A dish washing machine comprising:
a receiving space for receiving dishes;
a spray unit for supplying wash water into the receiving space; and
a steam generator for selectively supplying steam into the receiving space, the steam generator having a housing for containing water and a heater installed such that at least one portion of the heater is buried in a bottom of the housing to heat the water in the housing.
